(19) United States
(12) Patent Application Publication
(10) Pub. No.: US 2007/0042661 A1
(43) Pub. Date: Feb. 22, 2007

(54) Mineral fibre-based insulating panel, production method thereof and use of same

(76) Inventors: Enrico Ferri, Treviglio (IT); Sergio Mazzoleni, Bergamo (IT); Franco Valota, Bariano (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/573,076

(22) PCT Filed: Sep. 30, 2004
(86) PCT No.: PCT/FR04/02487

§ 371 Date: Oct. 26, 2006

(30) Foreign Application Priority Data
Sep. 30, 2003 (IT) MI2003A 001877

(51) Int. Cl. D03D 15/00; B32B 27/12

(52) U.S. Cl. 442/181; 442/286

(57) ABSTRACT

The invention relates to an insulating panel which is used as lagging for an electrical apparatus and which is based on mineral fibres, particularly glass fibres. The invention also relates to a method of producing one such panel. The inventive panel comprises a core (13; 113) of interconnected mineral fibres and a coating layer (9, 9′) which is applied to at least one face of the mineral fibre core (13; 113). The coating layer (9; 9′) comprises a non-woven fabric, a glass fabric or a glass mat and is connected to the mineral fibre core using a mineral chemical binder or a mechanical connection.

The present invention relates to an insulating panel based on mineral fibers such as glass fibers, glass wool, rockwool and the like, and to a method of producing such an insulating panel. For simplicity in that which follows, mention will chiefly be made of glass fiber panels.

Thermal insulating panels which are generally used for lagging electrical equipment, particularly household electrical equipment, for example electric or microwave ovens, refrigerators, boilers, air-conditioning equipment and the like, are widely used in the market.

Such panels have a core made of insulating material, for example glass fibers, which is possibly faced on one or both faces with an aluminum film. The aluminum facing layer is there to make the panels easier to handle, to hold in the dust created by the glass fibers, to reduce the risks of the glass fibers becoming teased out and stuck together when the panels are superposed or stacked.

These panels are generally positioned on the outside of the opening of the household electrical equipment, the aluminum facing of the panel generally being positioned on that face of the panel that faces toward the outside of the household electrical appliance. In general, these panels are not visible and are positioned in a gap formed in the casing of the household electrical appliance.

In general, before being assembled with the household electrical appliance, these panels are preformed with holes suitable for accommodating the fasteners and, for example, to allow for the passage of the electrical cables of the household electrical appliance.

The insulating panels in the prior art have various disadvantages due in the main to the electrical and thermal conductivity properties of the aluminum facing layer.

Specifically, since these panels often have electrical cables passing through them and are in contact with such cables, if these electric cables are not suitably insulated, the aluminum facing, which is electrically conductive, carries the risk of creating dangerous short circuits. The aluminum facing is also not elastic and therefore flexible enough and is also liable to split, creating the additional risk of sustaining cuts on its edges.

Furthermore, since the core of glass fibers is a good thermal insulator, whereas the aluminum facing is a good conductor of heat, a thermal bridge is created between the core of glass fibers and the aluminum facing and this compromises the insulating characteristics of the panel.

In order to produce these panels in the prior art, molten glass is first of all introduced into a fiberizing machine from which glass fibers emerge which are mixed with the binder and drop onto a conveyor belt on which air is sucked out of them before they are conveyed into an oven to stabilize the binder.

In an alternative to the use of a binder, in order to interconnect the glass fibers in the core of the panel, these glass fibers collected on the conveyor belt may undergo a needle punching operation in order to obtain a mechanical connection by recourse to special hooked needles.

In any case, what is obtained is a core or mat of glass fibers interconnected by chemical means (using a binder) or by mechanical means (by needle punching) and which is possibly wound into a roll so that it can be transported to a subsequent working phase in which the aluminum facings are bonded onto the wad of glass fibers using an appropriate silicate-containing adhesive.

Next, the mat of glass fibers with its aluminum facing is wound into rolls or possibly cut to form semi-finished panels which are cut in such a way as to obtain the desired dimensions with appropriate fixing and cable lead-through holes.

Finally, the rolls or the panels of semi-finished product are sent to a final drying phase to dry the adhesive used to apply the aluminum facing.

It has become evident that these processes for producing insulating panels are lengthy and expensive particularly as a result of the great number of phases needed for bonding the aluminum facing on.

The object of the present invention is to eliminate the disadvantages of the prior art by proposing an insulating panel based on glass fibers which has good lagging properties while at the same time providing good electrical insulation.

Another object of the invention is to propose an insulating panel which is extremely flexible and eliminates any cutting risk.

Yet another object of the present invention is to propose such an insulating panel which is versatile, practical for the user, economical and simple to produce.

According to the invention, these objects are achieved with the insulating panel that has the characteristics summarized in the attached independent claim 1.

Another object of the present invention is to propose a method for producing an insulating panel based on mineral fibers which is effective, quick and at the same time economical and simple.

According to the invention, this object is achieved using the methods of producing an insulating panel the phases of which are summarized in the attached claims 13 and 19 respectively.

A final object of the invention is the use of such an insulating panel in an electrical appliance, particularly a household electrical appliance, such as those mentioned above.

The insulating panel based on glass fibers according to the invention comprises a core of interconnected glass fibers and a facing layer connected to at least one face of the core of glass fibers.

The particular characteristic of the invention is that the facing layer comprises a woven-nonwoven (WNW), a woven fabric of mineral fibers or a web of mineral fibers, particularly of glass fibers. For convenience, in that which follows, the facing layer will be chiefly denoted a woven-nonwoven (WNW) layer, also commonly known as “nonwoven”.

It yields numerous advantages, both in the end-product and in the production process.

Specifically, the woven-nonwoven is a good insulator, both electrically and thermally. The result of this is that risks of short circuiting the electrical cables that pass through the panel are eliminated and, at the same time, no abrupt jumps in temperature between the core of glass wool and the woven-nonwoven facing layer are seen. Furthermore, the WNW facing improves the ease with which the panel can be handled by guaranteeing the user a better feel than panels with aluminum facing.

Furthermore, since the WNW is more elastic and flexible than aluminum, in addition to making the panel easier to handle, the risks of the edges of the panel splitting are avoided.

Other characteristics of the invention will become more clearly apparent from reading the detailed description which follows, which relates purely by way of nonlimiting example to the embodiments depicted in the attached drawings, in which:

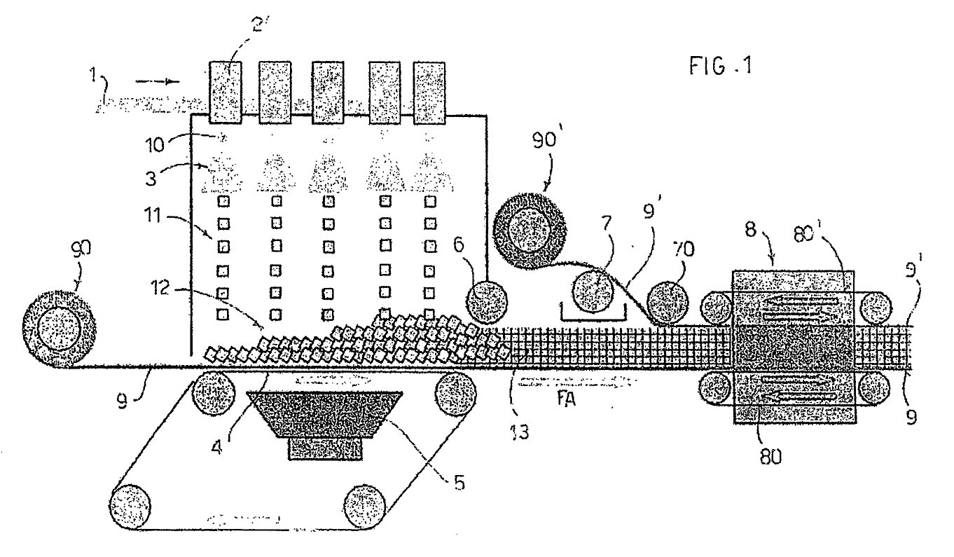

FIG. 1 is a functional diagram schematically representing the method of producing an insulating panel based on mineral fibers according to the invention, and

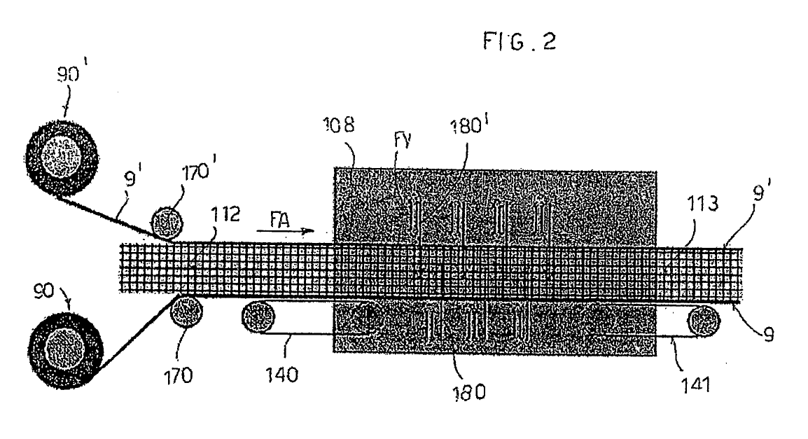

FIG. 2 is a functional diagram schematically depicting a second embodiment of the method of producing an insulating panel based on mineral fibers.

A first embodiment of the method of producing the insulating panel based on glass fibers according to the invention will now be described using FIG. 1.

A molten glass paste 1 is sent to a fiberizing machine 2 which produces a plurality of glass fibers 10.

The machine employs rotary fiberizing of the so-called internal centrifugation type, in which the molten material is received in a rotary component exhibiting symmetry of revolution and termed a spinner, having a wall pierced with a plurality of orifices through which the molten material is ejected and taken in hand by an stretching gas stream.

For the purposes of the present invention, the machine is set to produce fibers characterized by a micronaire of the order of 3 to 4.5 under a load of 5 g. According to the embodiment of FIG. 1, the fibers advantageously have a micronaire of the order of 3 to 3.8 under a load of 5 g.

The glass fibers 10 which leave the fiberizing machine 2 are transported through a spraying ring 3 in which one or more binders are sprayed these binders combining with the glass fibers 10 in order to promote chemical inter-bonding between them. By way of binder, use may be made of mineral binders such as, for example, an aqueous solution of aluminum polyphosphate salts.

In this way, glass fibers mixed with the binders 11 leave the spraying machine 3 and are gathered together on a support 9 to form a sparse mass 12 of glass fibers and binder in which the binder performs its binding action on the glass fibers. The support 9 has the form of a tape which is paid out from a master reel 90 and advanced in the direction of the arrow F_{A} using a conveyor 4.

The support 9 is a strip made of a woven-nonwoven (WNW), a woven glass fabric or a glass web. The support 9 is preferably made up of a woven-nonwoven based on plastic, for example derivatives of polyethylene and/or polyester, to which metal oxide fillers are possibly added.

In the region of the conveyor 4, under the support 9, there is a suction device 5 the function of which is to suck air from the sparse mass 12 of glass fibers and binder through the support 9 so as to extract the fiberglass dust and at the same time encourage a first reduction in the humidity of the fibers and binders.

It should be pointed out that, by virtue of the fact that use is being made of a support 9 made of a woven-nonwoven of a weight that allows air to be filtered, the air suction phase can be performed at the same time as the mass of glass fibers 12 is received on the support 9. This operation is clearly impossible if, by way of support 9, use is made of a metallic material, for example an aluminum film, as in the prior art, which does not allow air to pass. By way of indication, a weight of the order of 10 to 100 g/m² effectively fulfills the function of allowing the air to be sucked through.

Downstream of the suction device 5, and also downstream of the mass of glass fibers 12, there is a press roller 6 whose function is to perform a first compacting of the glass fibers so as to obtain a core or mat of essentially homogeneous glass fibers 13 arranged on the support 9. Adhesion between the lower support 9 and the mat of glass fibers 13 is guaranteed by the suction phase performed by the suction device 5 during which the humidity of the binder is reduced.

If, by way of end-product, a fiberglass panel with a facing on both sides is desired, then use is made of a second master reel 90′ from which a strip of WNW 9′ is unwound, advantageously essentially identical to the facing 9 unwound from the first master reel 90.

Downstream of the press roller 6, above the mat of compacted glass fibers 13, there is an “inking roller” unit 7 which comprises a binder distributing roller which picks up the binder from a vat situated underneath and spreads it over the underside of the strip of WNW 9′. The binder used in this phase may be the same binder as the one used in the spraying machine 3 in other aqueous solutions, or may be a different mineral binder.

The need to use the inking roller unit 7 is due to the fact that, downstream of the suction device 5, the binder added to the glass fibers during the spraying phase has generally dried to too great an extent or has completely dried and is therefore generally unable to attach the upper support to the mat of glass fibers 13.

Downstream of the inking roller unit 7 there is a press roller 70 which determines the coupling between the support 9′ and the mat of fibers 13. At this stage, the core of mineral fibers generally has a thickness of the order of 15 to 35 mm, particularly of the order of 20 to 30 mm.

In order to adhere the upper support 9′ to the mat of glass fibers 13, the mat of glass fibers 13 firmly sandwiched between the lower support 9 and the upper support 9′ is advanced by means of a lower conveyor belt 80 and of an upper conveyor belt 80′ into an oven 8 which dries the binder deposited by the inking roller unit 7 and therefore allows the upper support 9′ to adhere to the mat of glass fibers 13 and stabilizes the adhesive between the fibers. The operating temperature of the binder-drying oven 8 ranges between 100° C. and 200° C.

Finally, the layer of glass fibers 13 to which the lower support and the upper support 9, 9′ are bonded is taken up into a roll or is cut and trimmed directly to obtain insulating felt of appropriate dimensions, consisting of a layer of glass fibers 13 which are bonded together and bonded to at least one support 9, 9′ by means of binders of mineral type.

A second embodiment of the methods of producing an insulating panel based on glass fibers configured as variants to the method of FIG. 1 will now be described with reference to FIG. 2. Because of the similarity with the embodiment of FIG. 1, identical elements corresponding to those already described with reference to FIG. 1 are denoted by the same numerical references and are not described again in detail.

In this second embodiment, the glass fibers 10 leave the fiberizing machine 2 and are not mixed with binders able to create a chemical bond between the fibers. In this case, use is made of a minimum amount of agents the sole purpose of which is to hold in the dust rather than to create a chemical bond between the fibers. In general, by way of anti-dust additives, use is made of a type of agent known per se and termed Fomblin®.

According to the embodiment of FIG. 2, the fibers advantageously have a micronaire of the order of 3.5 to 4.5 under a load of 5 g.

At this point, the glass fibers are gathered together to form a mat 112 (FIG. 2) which can be rolled into a roll.

The mat of glass fibers 112 is advanced between two supports 9, 9′ paid out from first and second master reels 90, 90′ . Obviously, if the facing is wanted on just one face of the fibers, one of the two reels 90, 90′, preferably the upper reel 90′, may be omitted. Downstream of the reels 90, 90′, respective coupling rollers 170, 170′, able to tension the respective supports 9, 9′ are provided beneath and above the mat of glass fibers 112. The mat of glass fibers 112 with the respective supports 9, 9′ is advanced by means of a conveyor 140 in the direction of the arrow F_{A} toward a needle-punching machine 108.

The needle-punching machine 108 comprises a plurality of hooked needles 180 positioned under the plane of the lower support 9, and a plurality of hooked needles 180′ positioned above the plane of the upper support 9′. The lower needles 180 and the upper needles 180′ travel vertically in a reciprocating movement in the direction of the arrows Fᵥ.

In this way, the needles 180, 180′ pass through the respective supports 9, 9′ and connect the glass fibers of the mat 112 together and to the respective supports 9, 9′. As a result, upon leaving the needle-punching machine 108, we will have a mat or core of compact glass fibers 113 is obtained in which the glass fibers are mechanically connected together, mechanically connected to the lower support and mechanically connected to the upper support 9, 9′, respectively. It should be pointed out that, by virtue of the fact that use is made of a woven-nonwoven support 9, 9′ of a weight that is suitable to allow the needles 180, 180′ to pass, advantageously of the order of 10 to 100 g/m², the needle-punching phase can be performed directly on the supports 9, 9′, thus avoiding the subsequent phase of bonding the supports 9, 9′ to the mat of fibers 112. This operation is clearly impossible if, by way of supports 9, 9′, use is made of a metallic material, for example an aluminum film, as in the prior art, which would be punctured by the passage of the needles 180, 180′ without in any way creating a connection between the film and the core of fibers.

Such a mat of fibers 113 with mechanically-connected respective supports 9, 9′ is transported out of the needle-punching machine 108 by means of a conveyor 141 and from there is sent on to the subsequent phases of rolling it into a roll and then cutting and/or trimming, in order to obtain the desired products.

Numerous variations and modifications in detail that are within the competence of a person skilled in the art can be made to the present embodiments of the invention, these all, however, being included within the scope of the invention as defined by the attached claims.

1. An insulating panel for lagging electrical equipment, the panel comprising mineral fibers, and comprising a core of interconnected mineral fibers and a facing layer applied to at least one face of said core of mineral fibers, wherein said facing layer comprises a woven-nonwoven (WNW), a woven mineral fiber fabric or a web of mineral fibers, and wherein the facing layer is chemically bonded to the mineral fibers of the core by a mineral binder or is mechanically connected to the mineral fibers of the core.

2. The panel as claimed in claim 1, wherein said facing layer comprises a woven fabric or a web of glass fibers.

3. The panel as claimed in claim 1, wherein said facing layer comprises a woven-nonwoven (WNW) of polymer synthetic fibers, comprising derivatives of polyethylene and of polyester to which metal oxide fillers are optionally added.

4. The panel as claimed in claim 1, wherein said facing layer has a thickness lying, by way of indication, in the range from 0.05 mm to 1.5 mm.

5. The panel as claimed in claim 1, wherein said facing layer has a weight lying, by way of indication, in the range from 10 g/m² to 100 g/m².

6. The panel as claimed in claim 1, wherein the core of mineral fibers has a mass per weight area of the order of 600 to 1000 g/m².

7. The panel as claimed in claim 1, wherein the core of mineral fibers comprises glass fibers with a micronaire of the order of 3 to 4.5 under a load of 5 g.

8. The panel as claimed in claim 1, wherein the panel comprises chemical binders in order both to form a chemical bond between the mineral fibers of the core and to form a chemical bond between the facing layer and the mineral fibers of the core.

9. The panel as claimed in claim 8, wherein said chemical binder is a mineral binder consisting of an aqueous solution of aluminum polyphosphate salts.

10. The panel as claimed in claim 1, wherein said mineral fibers of the core are mechanically interconnected and in that said facing layer is mechanically connected to the mineral fibers of the core.

11. The panel as claimed in claim 10, wherein said mechanical connection is obtained by needle punching the mineral fibers together and by needle punching the mineral fibers to the facing layer.

12. The panel as claimed in claim 10, where the panel comprises an anti-dust agent such as Fomblin® between the mineral fibers of the core.

13. A method for producing an insulating panel based on mineral fibers as claimed claim 1, comprising:
spinning mineral fibers from a molten mineral substance,
producing a chemical-type bond between said mineral fibers so as to obtain a core of chemically inter-bonded mineral fibers,
producing a chemical-type bond between said core of mineral fibers and a facing layer positioned on at least one face of said core of mineral fibers.

14. The method as claimed in claim 13, wherein said phase of bonding the mineral fibers together takes place at the same time as the step of bonding the mineral fibers to the facing layer by recourse to a chemical-type bond.

15. The method as claimed in claim 13, wherein said chemical-type bonding comprises the following phases:
adding a mineral binder to the mineral fibers,
receiving the mineral fibers together with the mineral binder on a strip of said facing layer,
sucking air through said facing layer and then drying said mineral binders in order to create the bond between the mineral fibers and the bond between the mineral fibers and the facing layer.

16. The method as claimed in claim 15, further comprising:
depositing the mineral binder on a second facing layer and
applying said second facing layer onto the opposite surface of the core of mineral fibers to the one to which said first facing layer is bonded so that said mineral binder is located between said second facing layer and one face of the core of mineral fibers.

17. The method as claimed in claim 16, further comprising drying said mineral binder deposited between said second facing layer and a surface of the core of mineral fibers by heating.

18. The method as claimed in claim 17, wherein said step of drying the mineral binder by heating is performed at a temperature ranging between 100° C. and 200° C.

19. A method for producing an insulating panel based on mineral fibers as claimed in claim 10, comprising:
spinning mineral fibers from a molten mineral substance,
producing a mechanical-type connection between said mineral fibers so as to obtain a core of mechanically interconnected mineral fibers,
producing a mechanical-type connection between said core of mineral fibers and a facing layer positioned on at least one face of said core of mineral fibers.

20. The method as claimed in claim 19, wherein said phase of bonding the mineral fibers together takes place at the same time as the step of bonding the mineral fibers to the facing layer using a connection of a mechanical type.

21. The method as claimed in claim 19, wherein said connection of a mechanical type is achieved by needle punching, in which hooked needles pass through said facing layer to mechanically connect the mineral fibers of the core to one another and to the facing layer.

22. The method as claimed in claim 19, comprising adding anti-dust agents to the mineral fibers prior to the mechanical-connection step.

23. The method as claimed in claim 13, wherein the step of spinning the mineral fibers from a molten mineral substance is performed using a rotary process involving internal centrifugation.

24. (canceled)

25. An article comprising the insulating panel as claimed in claim 1.

26. The article as claimed in claim 25, wherein the article is an electrical equipment, a household electrical equipment, an electric oven, a microwave oven, a refrigerator, a boiler or an air-conditioning equipment.

27. The panel as claimed in claim 1, wherein the mineral fibers are at least one selected from the group consisting of glass fiber, glass wool and rockwool.
